(19) United States
(12) Patent Application Publication
(10) Pub. No.: US 2026/0192846 A1
(43) Pub. Date: Jul. 9, 2026

(54) CONVERTIBLE WAGON, CAR SEAT, STROLLER, AND BUCKET CARRIER CHILD TRANSPORT SYSTEM

(71) Applicant: Haoqun WANG, Hangzhou, Zhejiang (CN)

(72) Inventor: Haoqun WANG, Hangzhou, Zhejiang (CN)

(21) Appl. No.: 19/131,611

(22) PCT Filed: Jul. 17, 2024
(86) PCT No.: PCT/CN2024/105877

§ 371 Date: May 21, 2025

Related U.S. Application Data
(60) Provisional application No. 63/527,718, filed on Jul. 19, 2023.

(30) Foreign Application Priority Data
Nov. 3, 2023 (CN) 202322976254.4

(51) Int. Cl. B62B 7/10; B60N 2/28; B60N 2/809

(52) U.S. Cl. CPC B62B 7/10; B60N 2/2821; B60N 2/809

(57) ABSTRACT

A child transport system (100) can include a seat system (102) including a first seat shell, a second seat shell, and an extendible frame (170), the first seat shell and the second seat shell each being attached to the extendible frame (170), the first seat shell being slidable along a linear axis (E) relative to the second seat shell between a first position and a second position, a set of front wheel assemblies (106a, 106b) rotatably attached to the seat system (102), and a set of rear wheel assemblies (104a, 104b) rotatably attached to the seat system (102). The child transport system (100) is configurable between multiple configurations including a bucket carrier, a car seat, a stroller, and a wagon.

### CROSS-REFERENCE TO RELATED APPLICATIONS

This application claims the benefit of and priority to U.S. Prov. App. No. 63/527,718, filed on Jul. 19, 2023 and CN 202322976254.4, filed on Nov. 3, 2023, the disclosures of which are incorporated herein by reference in the entirety for all purposes.

### BACKGROUND

Carrier products can be used to transport children (e.g., infants, toddlers) and can include car seats, strollers, bucket carriers, wagons, and the like. As a group, carrier products provide a collective transport solution for children, and can be collectively referred to as child travel systems. However, each carrier product performs a respective function. As such, parents can require a separate carrier product for each function, which results in bulky, cumbersome transport.

### SUMMARY

Implementations of the present disclosure are generally directed to carrier products. More particularly, implementations of the present disclosure are directed to a child transport system that is configurable between multiple configurations including a bucket carrier, a car seat, a stroller, and a wagon.

In some implementations, a child transport system includes a seat system including a first seat shell, a second seat shell, and an extendible frame, the first seat shell and the second seat shell each being attached to the extendible frame, the first seat shell being slidable along a linear axis relative to the second seat shell between a first position and a second position, a set of front wheel assemblies rotatably attached to the seat system, and a set of rear wheel assemblies rotatably attached to the seat system.

These and other implementations can each optionally include one or more of the following features: the child transport system is configurable between multiple configurations including a stroller configuration, in which the seat system is in the first position and each of the set of front wheel assemblies and the set of rear wheel assemblies is in an extended position, and a wagon configuration, in which the seat system is in the second position and each of the set of front wheel assemblies and the set of rear wheel assemblies is in the extended position; the multiple configurations further include a bucket carrier configuration, in which the seat system is in the second position and each of the set of front wheel assemblies and the set of rear wheel assemblies is in a stowed position; the child transport system further includes a car seat base, the seat system being configured for releasable attachment to the car seat base, the child transport system being configurable to a car seat configuration, in which the seat system is in the second position and each of the set of front wheel assemblies and the set of rear wheel assemblies is in a stowed position and the seat system is attached to the car seat base; the extendible frame includes sets of frame rails, each set of frame rails including a first frame rail and a second frame rail, the first seat shell being attached to each of the first frame rails, the second seat shell attached to each of the second frame rails; the first frame rail is slidable within the second frame rail; the child transport system further includes a headrest that is adjustable along a linear axis that is parallel to an angle of incline of a seatback of the seat system; the child transport system further includes one or more of a set of suspension systems integrated into hubs of the set of rear wheel assemblies and hubs of the set of front wheel assemblies and a set of suspension systems integrated into legs of the set of rear wheel assemblies; the child transport system further includes a pushbar that is rotatable about an axis, rotation of the pushbar driving rotation the set of rear wheel assemblies about at least a portion of the axis; and the seat system includes a substantially flat base that is parallel to a horizontal plane.

In some implementations, a child transport system includes a seat system including a first seat shell, a second seat shell, and an extendible frame, the first seat shell and the second seat shell each being attached to the extendible frame, the first seat shell being slidable within the second seat shell along a linear axis between a first position and a second position to adjust a length of the seat system along the linear axis, a set of front wheel assemblies rotatably attached to the first seat shell, and a set of rear wheel assemblies rotatably attached to the second seat shell, the child transport system being configurable between multiple configurations including a stroller configuration, in which the seat system is locked in the first position and a wagon configuration, in which the seat system is locked in the second position.

These and other implementations can each optionally include one or more of the following features: in the stroller configuration, each of the set of front wheel assemblies and the set of rear wheel assemblies is in an extended position and, in the wagon configuration, each of the set of front wheel assemblies and the set of rear wheel assemblies is in the extended position; the multiple configurations further includes a bucket carrier configuration, in which the seat system is in the second position and each of the set of front wheel assemblies and the set of rear wheel assemblies is in a stowed position; the child transport system further includes a car seat base, the seat system being configured for releasable attachment to the car seat base, the child transport system being configurable to a car seat configuration, in which the seat system is in the second position and each of the set of front wheel assemblies and the set of rear wheel assemblies is in a stowed position and the seat system is attached to the car seat base; the extendible frame includes sets of frame rails, each set of frame rails including a first frame rail and a second frame rail, the first seat shell being attached to each of the first frame rails, the second seat shell attached to each of the second frame rails; the first frame rail is slidable within the second frame rail; the child transport system further includes a headrest that is adjustable along a linear axis that is parallel to an angle of incline of a seatback of the seat system; the child transport system further includes one or more of a set of suspension systems integrated into hubs of the set of rear wheel assemblies and hubs of the set of front wheel assemblies and a set of suspension systems integrated into legs of the set of rear wheel assemblies; the child transport system further includes a pushbar that is rotatable about an axis, rotation of the pushbar driving rotation the set of rear wheel assemblies about at least a portion of the axis; and the seat system includes a substantially flat base that is parallel to a horizontal plane.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an isometric view of a child transport system in a bucket carrier configuration in accordance with implementations of the present disclosure.

FIG. 2 depicts a side view of the child transport system of the present disclosure in the bucket carrier configuration.

FIG. 3 depicts a front view of the child transport system of the present disclosure in the bucket carrier configuration.

FIG. 4 depicts a rear view of the child transport system of the present disclosure in the bucket carrier configuration.

FIG. 5 depicts a top view of the child transport system of the present disclosure in the bucket carrier configuration.

FIG. 6 depicts a bottom view of the child transport system of the present disclosure in the bucket carrier configuration.

FIG. 7 depicts an isometric view of the child transport system of the present disclosure in a stroller configuration.

FIG. 8 depicts a side view of the child transport system of the present disclosure in the stroller configuration.

FIG. 9 depicts an isometric view of a car seat base for the child transport system of the present disclosure in a car seat configuration.

FIG. 10 depicts an isometric view of the child transport system of the present disclosure mounted to the car seat based of FIG. 9 in the car seat configuration.

FIG. 11 depicts a side view of the child transport system of the present disclosure in a wagon configuration.

FIG. 12 depicts an isometric view of the child transport system of the present disclosure in the wagon configuration.

FIG. 13 depicts a top view of the child transport system of the present disclosure in the wagon configuration.

FIG. 14 depicts a bottom view of the child transport system of the present disclosure in the wagon configuration.

FIG. 15 depicts a side view of a seat system of the child transport system of the present disclosure.

FIG. 16 depicts a rear view of the seat system of the child transport system of the present disclosure.

FIG. 17 depicts an isometric view of the seat system of the child transport system of the present disclosure.

FIG. 18 depicts an exploded view of the seat system of the child transport system of the present disclosure.

FIG. 19 depicts a bottom view of a portion of the seat system of the child transport system of the present disclosure.

FIG. 20 depicts a partial cross-section view of the child transport system including an extendible in accordance with implementations of the present disclosure.

FIG. 21 depicts a cross-sectional view of a rear suspension system of the child transport system of the present disclosure.

FIG. 22 depicts a cross-sectional view of a front suspension system of the child transport system of the present disclosure.

FIG. 23 depicts a cross-sectional view of a leg assembly suspension system of the child transport system of the present disclosure.

Like reference numbers and designations in the various drawings indicate like elements.

### DETAILED DESCRIPTION

Implementations of the present disclosure are generally directed to carrier products, such as carriers for infants, toddlers, and the like. More particularly, implementations of the present disclosure are directed to a carrier product, namely, a child transport system, that is configurable between multiple configurations including a bucket carrier, a car seat, a stroller, and a wagon.

In some implementations, a child transport system includes a seat system including a first seat shell, a second seat shell, and an extendible frame, the first seat shell and the second seat shell each being attached to the extendible frame, the first seat shell being slidable along a linear axis relative to the second seat shell between a first position and a second position, a set of front wheel assemblies rotatably attached to the seat system, and a set of rear wheel assemblies rotatably attached to the seat system. In some implementations, a child transport system includes a seat system including a first seat shell, a second seat shell, and an extendible frame, the first seat shell and the second seat shell each being attached to the extendible frame, the first seat shell being slidable within the second seat shell along a linear axis between a first position and a second position to adjust a length of the seat system along the linear axis, a set of front wheel assemblies rotatably attached to the first seat shell, and a set of rear wheel assemblies rotatably attached to the second seat shell, the child transport system being configurable between multiple configurations including a stroller configuration, in which the seat system is locked in the first position and a wagon configuration, in which the seat system is locked in the second position.

To provide further context for implementations of the present disclosure, and as introduced above, carrier products can be used to transport children (e.g., infants, toddlers) and can include car seats, strollers, bucket carriers, wagons, and the like. As a group, carrier products provide a collective transport solution for children. Each carrier product performs a respective function and, as such, parents can require a separate carrier product for each function, which results in bulky, cumbersome transport. Some carrier products include variations of combinations, such as a wagon and stroller combination, a bucket carrier and stroller combination, and a bucket carrier and car seat combination. Alternatively, conventional child travel systems may include a primary wagon, stroller, car seat, or car seat base with the addition of add-ons that allow for convertibility. However, a comprehensive child transport solution that combines all functions is lacking.

In view of the above context, implementations of the present disclosure provide a carrier product, namely, a child transport system, that is configurable between multiple configurations including a bucket carrier, a car seat, a stroller, and a wagon. As described in further detail herein, the child transport system of the present disclosure can be described as a four-in-one (4-in1) carrier product in that the single carrier can be configured into four configurations. More particularly, the child transport system of the present disclosure performs four functions in a single carrier product.

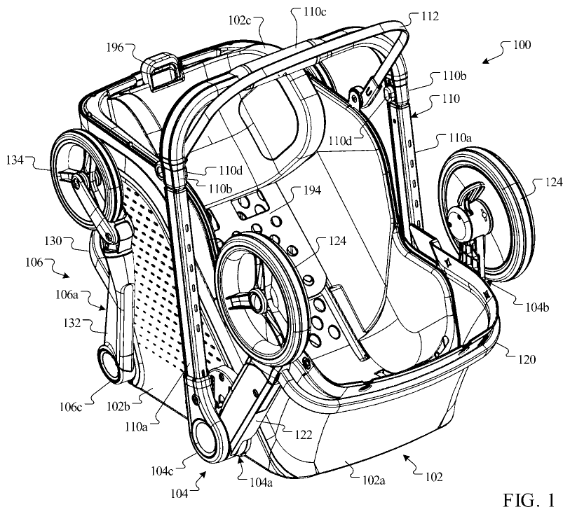

FIGS. 1-6 depict respective views of a child transport system 100 in a bucket carrier configuration in accordance with implementations of the present disclosure. With collective reference to FIGS. 1-6, the child transport system 100 includes a seat system 102, a set of rear wheels 104, a set of front wheels 106, a pushbar 110, and a cover support 112. The seat system 102 includes a rear seat shell 102a, a front seat shell 102b, and a headrest 102c. As described in further detail herein, the set of rear wheels 104 and the set of front wheels 106 are each rotatable relative to the seat system 102 to enable changing of the child transport system 100 between configurations. As also described in further detail herein, the rear seat shell 102a and the front seat shell 102b are movable relative to each other to enable changing of the child transport system 100 between configurations.

In further detail, the set of rear wheels 104 includes a rear wheel assembly 104a and a rear wheel assembly 104b. The set of front wheels 106 includes a front wheel assembly 106a and a front wheel assembly 106b. The rear wheel assemblies 104a, 104b are connected by a crossbar 120 and each includes a leg assembly 122 and a wheel assembly 124. The front wheel assemblies 106a, 106b are connected by a crossbar 130 and each includes a leg assembly 132 and a wheel assembly 134. The set of rear wheels 104 is connected to the seat system 102 at hubs 104c and the set of front wheels 106 is connected to the seat system 102 at hubs 106c.

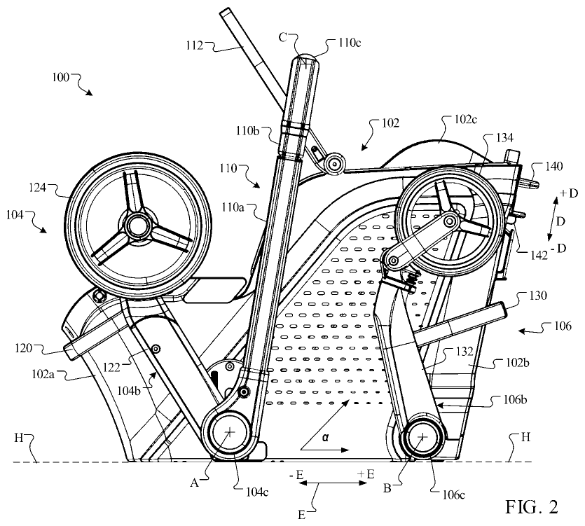

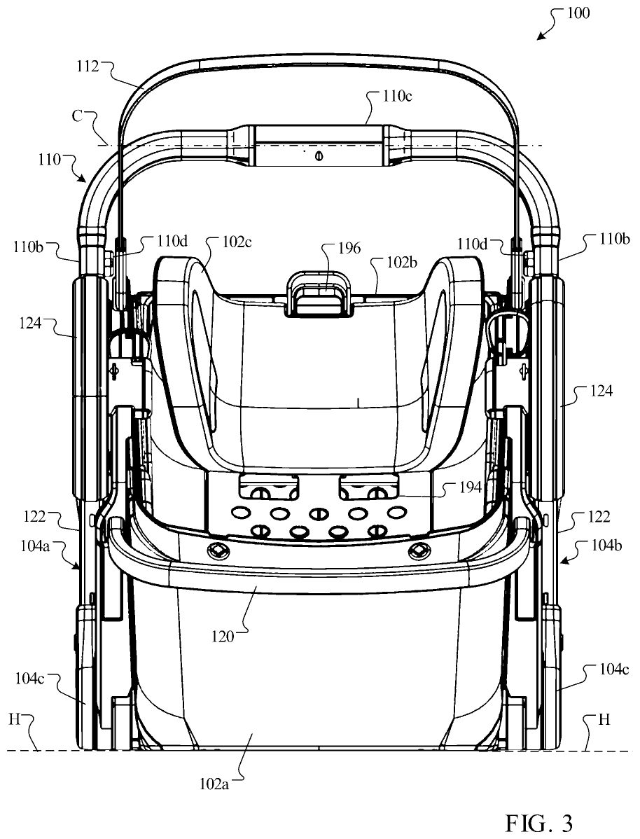

With particular reference to FIGS. 2 and 3, the child transport system 100 includes a substantially flat base that is parallel to a horizontal plane H. In this manner, the child transport system 100 is stable when sitting on a flat surface. That is, the substantially flat base prevents tipping of the child transport system 100.

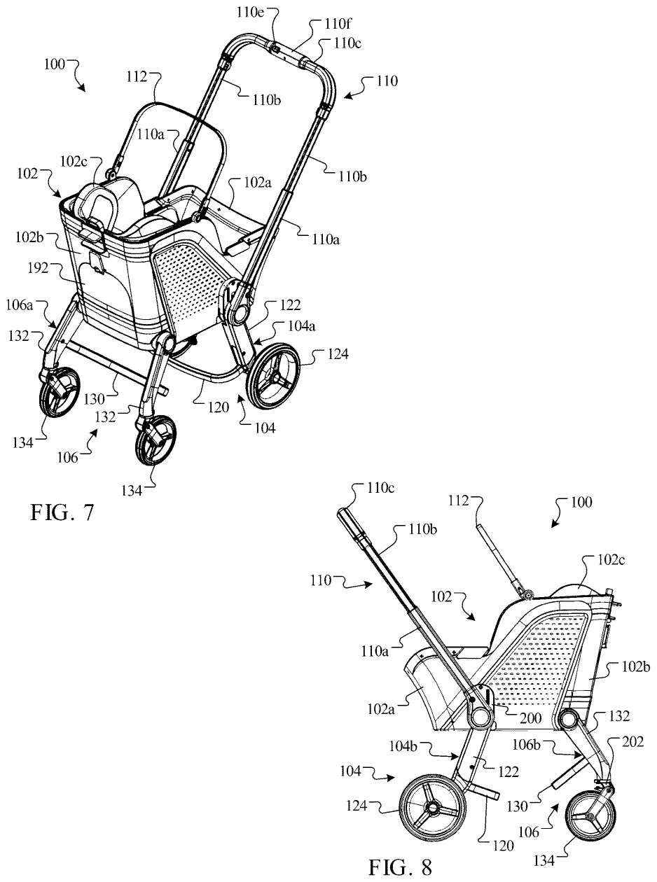

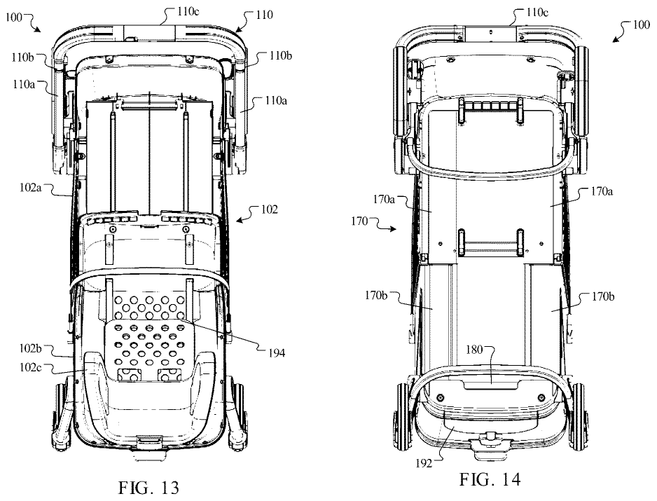

With continued reference to FIG. 2, the set of rear wheels 104 is rotatable about an axis A and the set of front wheels 106 is rotatable about an axis B. In some examples, the hubs 104c include hub locks therein, which selectively prohibit rotation of the set of rear wheels 104 about the axis A. In some examples, the hubs 106c include hub locks therein, which selectively prohibit rotation of the set of from wheels 106 about the axis B. The set of rear wheels 104 is selectively rotatable between a stowed position, as depicted in FIGS. 1-6, and an extended position, as depicted in FIGS. 7, 8, and 11-14. The set of front wheels 106 is selectively rotatable between a stowed position, as depicted in FIGS. 1-6, and an extended position, as depicted in FIGS. 7, 8, and 11-14. In the stowed position, the child transport system 100 is in the bucket carrier configuration or the car seat configuration. In the extended position, the child transport system 100 is in the stroller configuration or the wagon configuration.

In some implementations, the pushbar 110 includes lower pushbar rails 110a, upper pushbar rails 110b, and a grip 110c. In some examples, the upper pushbar rails 110b are slidable with respect to the lower pushbar rails 110a. For example, the upper pushbar rails 110b can be slidable within the lower pushbar rails 110a. In this manner, the grip 110c can be positioned at a selected distance to the axis A. For example, in a fully extended position, the grip 110c is at a maximum distance from the axis A (see, e.g., FIGS. 7 and 8) and, in a fully retracted position, the grip 110c is at a minimum distance from the axis A (see, e.g., FIGS. 1-4). In some examples, an amount of extension of the upper pushbar rails 110b relative to the lower pushbar rails 110a can be selected by a user. For example, the pushbar 110 can include an extension locking mechanism that enables the pushbar 110 to be switched between a locked mode and an unlocked mode. In some examples, the extension locking mechanism can include buttons 110d that can be depressed by the user (see, e.g., FIGS. 1, 3, and 4) to enter the unlocked mode, in which the upper pushbar rails 110b are slidable relative to the lower pushbar rails 110a. Release of pressure on the buttons 110d by the user (e.g., springs bias the buttons 110d against user pressure) results in entering the locked mode, in which the upper pushbar rails 110b are locked from sliding relative to the lower pushbar rails 110a.

In some implementations, the pushbar 110 is rotatable about the axis A between a carrier position (see, e.g., FIGS. 1-5) and a push position (see, e.g., FIGS. 7, 8, 11, 12). In some implementations, the pushbar 110 includes a rotation locking mechanism that enables the pushbar 110 to be switched between a rotation locked mode and a rotation unlocked mode. In the rotation locked mode, the pushbar 110 is locked from rotation about the axis A. In the rotation unlocked mode, the pushbar 110 is free to rotate about at least a portion of the axis A.

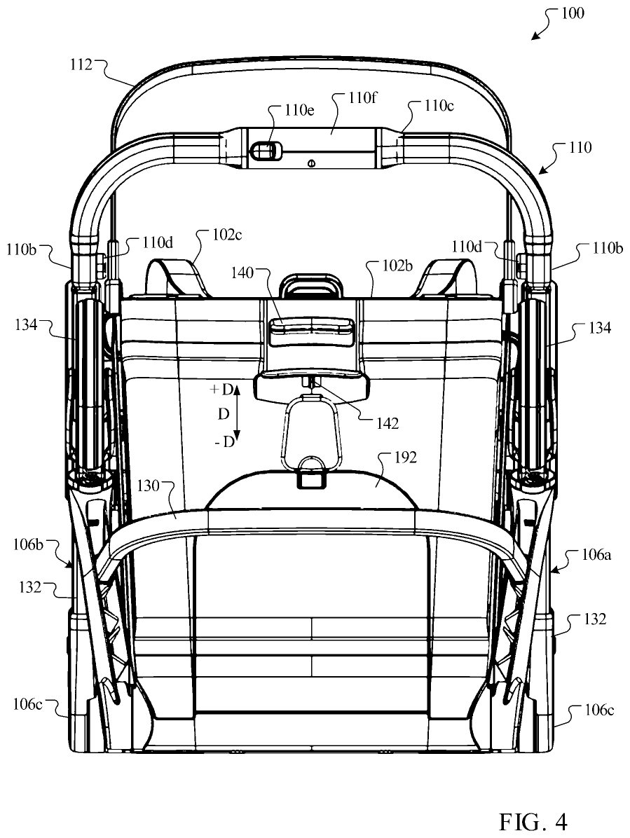

In further detail, and with particular reference to FIGS. 4 and 7, the rotation locking mechanism includes a button 110e that is biased (e.g., by a spring) in a first direction to maintain the rotation locked mode. The button 110e can be pushed (e.g., by a user) in a second direction, against the bias, to enter the rotation unlocked mode, in which, at least a portion 110f of the grip 110c can rotate about an axis C (see FIGS. 1 and 3) from a first rotational position to a second rotational position. In the second rotational position, the pushbar 110 is in the rotation unlocked mode. In some examples, the portion 110f is biased toward the first position by a spring (e.g., a torsional spring about the axis C) of the rotation locking mechanism.

In accordance with implementations of the present disclosure, when the rotation locking mechanism is in the rotation unlocked mode rotation of the pushbar 110 about the axis A is enabled, as well as rotation of the set of rear wheels 104 about the axis A. For example, in the rotation unlocked mode, hub locks of the set of rear wheels 104 are released to enable rotation, as described in further detail herein. In some examples, rotation of the pushbar 110 about the axis A induces rotation of the set of rear wheels 104 about the axis A. In this manner, as the pushbar 110 rotates from the carrier position (see, e.g., FIG. 2) to the push position (see, e.g., FIG. 8), the set of rear wheels 104 is induced to rotate from the stowed position (see, e.g., FIG. 2) at least partially toward the extended position (see, e.g., FIG. 8). In this manner, the child transport system 100 can (at least partially) be converted to one of the stroller configuration and the wagon configuration. In either the stowed position or the extended position, the hub locks of the set of rear wheels 104 are locked to inhibit rotation of either the pushbar 110 or the set of rear wheels 104 about the axis A.

With particular reference to FIGS. 2 and 4, a locking mechanism is provided in the seat system 102 to selectively lock the set of front wheels 106 in the stowed position (see, e.g., FIG. 2) or the extended position (see, e.g., FIG. 8). More particularly, a handle 140 of the locking mechanism is slidable along an axis D and is biased (e.g., by one or more springs) in a first direction (e.g., +D). A button 142 is provided, which can be pressed orthogonal to the axis D to release the handle 140 for movement. More particularly, with the button 142 pressed, a user can push the handle 140 in a second direction (e.g., −D) of the axis D, which induces the locking mechanism to unlock hub locks of the set of front wheels 106 and enable the set of front wheels 106 to rotate about the axis B. In this manner, the child transport system 100 can (at least partially) be converted to one of the stroller configuration and the wagon configuration. In either the stowed position or the extended position, the hub locks of the set of front wheels 106 are locked to inhibit rotation of the set of front wheels 106 about the axis B.

Accordingly, to convert the child transport system 100 to one of the stroller configuration and the wagon configuration from the bucket carrier configuration (i.e., moving both the set of rear wheels 104 and the set of front wheels 106 to the extended position) a two-step process can be executed. In a first step, the button 142 is pressed and the handle 140 is simultaneously pushed in the second direction along the axis D to unlock the hubs of the set of front wheels 106 to enable the set of front wheels 106 to fall with gravity, rotating about the axis B to the extended position. Once in the extended position, the hubs 106c of the set of front wheels 106 automatically lock (e.g., by spring bias) to prevent the set of front wheels 106 from rotating out of the extended position. In a second step, the button 110d can be pushed and the portion 110e of the grip 110c can be simultaneously rotated about the axis C to unlock the hubs 104c of the set of rear wheels 104. This enables the pushbar 110 to rotate toward the push position and induce rotation of the set of rear wheels 104 toward the extended position. After the pushbar 110 is in the push position, the set of rear wheels 104 can fall with gravity, rotating about the axis A, to the extended position. Once in the extended position, the hubs 104c of the set of rear wheels 104 automatically lock (e.g., by spring bias) to prevent the set of rear wheels 104 from rotating out of the extended position. It is contemplated that the first step and the second step can be interchanged (e.g., the set of rear wheels 104 can be moved to the extended position, then the set of front wheels 106 can be moved to the extended position).

Similarly, to convert the child transport system 100 to the bucket carrier from one of the stroller configuration and the wagon configuration (i.e., moving both the set of rear wheels 104 and the set of front wheels 106 to the stowed position) a two-step process can be executed. In a first step, the button 142 is pressed and the handle 140 is simultaneously pushed in the second direction along the axis D to unlock the hubs 106c of the set of front wheels 106 to enable the set of front wheels 106 to rotate about the axis B to the stowed position. Once in the stowed position, the hubs 106c of the set of front wheels 106 automatically lock (e.g., by spring bias) to prevent the set of front wheels 106 from rotating out of the stowed position. In a second step, the button 110d can be pushed and the portion 110e of the grip 110c can be simultaneously rotated about the axis C to unlock the hubs 104c of the set of rear wheels 104. This enables the pushbar 110 to rotate toward the carrier position and induce rotation of the set of rear wheels 104 toward the stowed position. After the pushbar 110 is in the carrier position and the set of rear wheels 104 is in the stowed position, the hubs 104c of the set of rear wheels 104 automatically lock (e.g., by spring bias) to prevent the set of rear wheels 104 from rotating out of the stowed position. It is contemplated that the first step and the second step can be interchanged (e.g., the set of rear wheels 104 can be moved to the stowed position, then the set of front wheels 106 can be moved to the stowed position).

In the bucket carrier configuration, the set of rear wheels 104 is in the stowed position at a foot end (e.g., the end where the feet of a child would be positioned) of the seat assembly 102 along the rear seat shell 102a and the set of front wheels 106 is in the stowed position at a head end (e.g., the end where the feet of a child would be positioned) of the seat assembly 102 along the front seat shell 102b.

FIGS. 7 and 8 depict respective views of the child transport system 100 of the present disclosure in the stroller configuration.

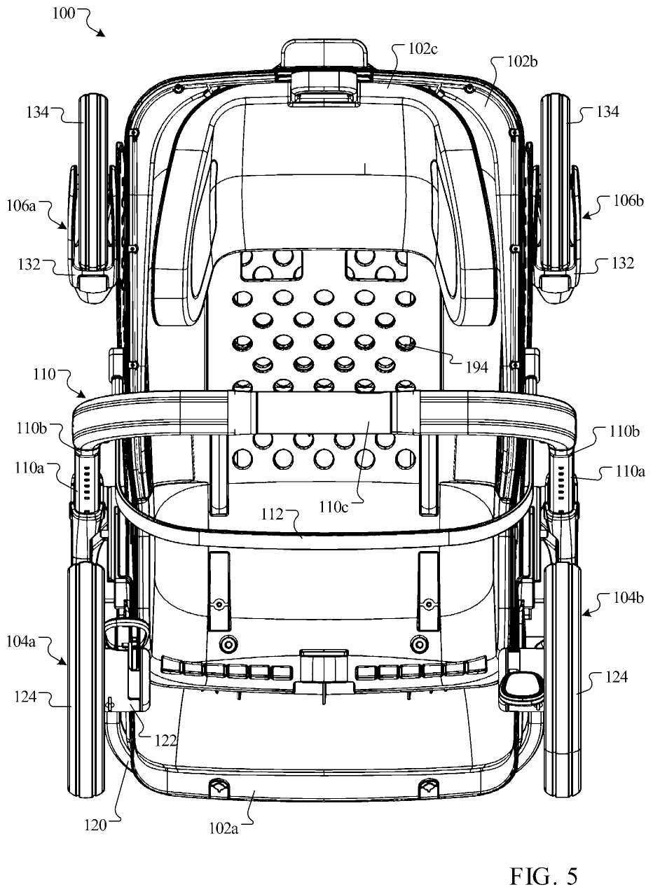

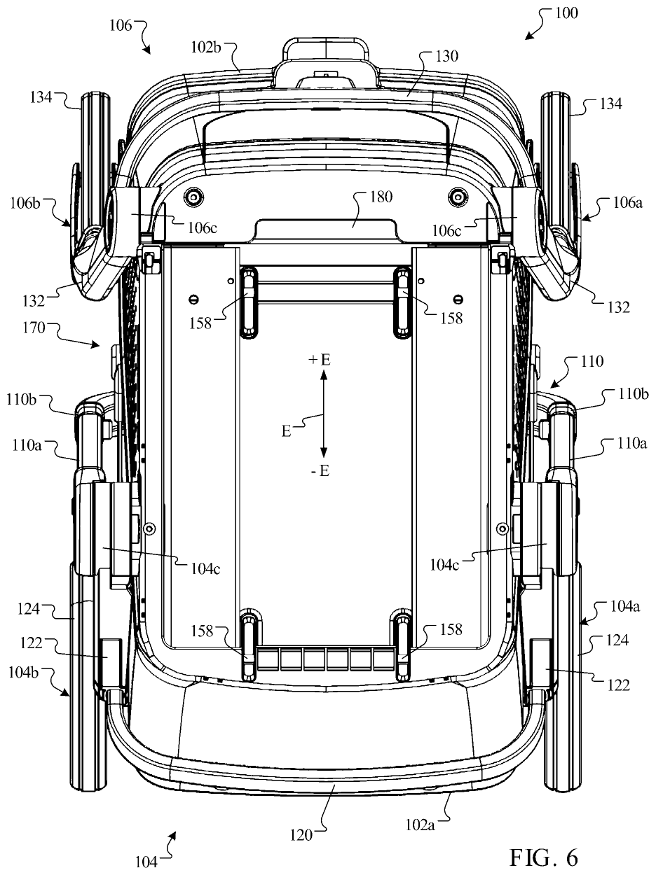

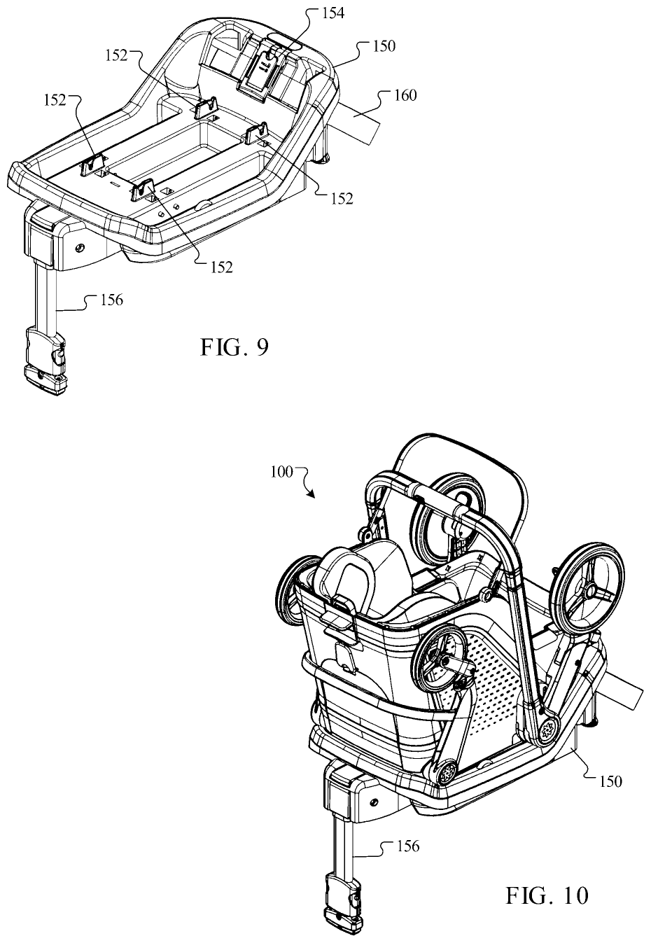

FIG. 9 depicts an isometric view of a car seat base 150 for the child transport system 100 of the present disclosure in a car seat configuration. FIG. 10 depicts an isometric view of the child transport system 100 of the present disclosure mounted to the car seat base 150 of FIG. 9 in the car seat configuration. In the example of FIG. 9, the car seat base 150 includes latches 152, an anchor system 154, and a stabilizer 156. In some examples, the latches 152 releasable secure the child transport system 100 to the car seat base 150. For example, the latches 152 can latch to latch anchors 158 (see FIG. 6) of the child transport system 100 to secure the child transport system 100 to the car seat base 150. The latches 152 can be released to enable the child transport system 100 to be detached from the car seat base 150. The anchor system 154 can receive an anchor strap 160 (e.g., a seat belt) of a vehicle for securing the car seat base 150 within the vehicle.

The stabilizer 156 can be used to provide stability for the car seat base 150 (and the child transport system 100 when attached to the car seat base 150) within the vehicle. For example, the stabilizer 156 can rest on a floor of the vehicle to provide another point of contact with the vehicle. In some examples, a length of the stabilizer 156 is adjustable to adapt to heights of different vehicle seats from the floor. In some examples, the stabilizer 156 is not needed for stability. As such, the stabilizer 156 can be folded under the car seat base 150.

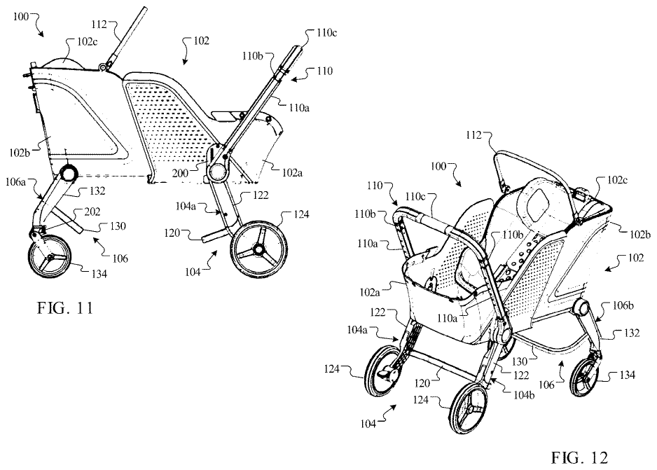

In accordance with implementations of the present disclosure, the child transport system 100 of the present disclosure can be configured to a wagon configuration. FIGS. 11-14 depict respective views of the child transport system 100 of the present disclosure in the wagon configuration. In the wagon configuration, the seat system 102 is in an extended position. More particularly, and as depicted in FIGS. 2 and 8, for example, the seat system 102 is in a retracted position in the bucket carrier configuration (and car seat configuration) and the stroller configuration. To move to the wagon configuration, the rear seat shell 102a and the front seat shell 102b are movable relative to each other.

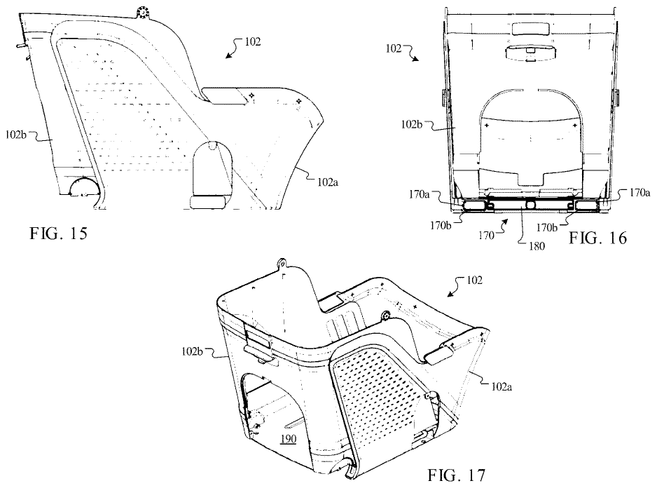

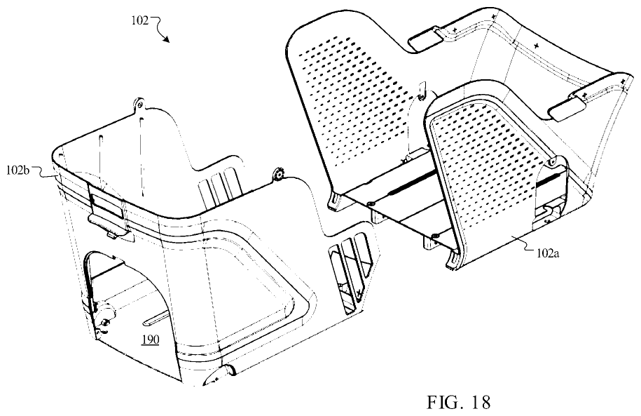

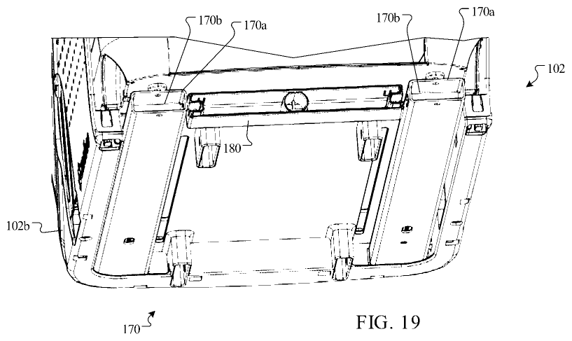

FIGS. 15-20 depict respective views of portions of the seat system 202 of the child transport system 100 of the present disclosure. With particular reference to FIGS. 6, 14, 16, 19, and 20, the seat system 102 includes an extendible frame 170 that enables the rear seat shell 102a and the front seat shell 102b to slide relative to one another along a linear axis E. The linear axis E is a horizontal axis that is substantially horizontal to a surface, such as a floor. More particularly, the linear axis E is linear and is absent any curvature. In some examples, the extendible frame 170 includes outer frame rails 170a and inner frame rails 170b. The inner frame rails 170b are slidably received into the outer frame rails 170 to be slidable along the linear axis E. In some examples, the rear seat shell 102a is secured to the outer frame rails 170a and the front seat shell 102b is secured to the inner frame rails 170b. In this manner, the front seat shell 102b can slide with the inner frame rails 170b along the axis E relative to the rear seat shell 102a and the outer frame rails 170a.

In some implementations, a locking mechanism is provided to lock the inner frame rails 170b within the outer frame rails 170a to inhibit sliding along the axis E. In some examples, the locking mechanism includes a handle 180 that enables the extendible frame 170 to be switched between a locked mode and an unlocked mode. For example, the locking mechanism can bias the handle 180 in the −E direction along the axis E, in which the extendible frame 170 is in the locked mode. In some examples, the locking mechanism includes one or more pins that are received through openings of the inner frame rails 170b and openings of the outer frame rails 170a to inhibit sliding in the locked mode. The handle 180 can be pressed (e.g., by the user) in the +E direction of the axis E against the bias to enter the unlocked mode, in which the inner frame rails 170b are slidable within the outer frame rails 170a. In some examples, in the unlocked mode, the one or more pins that are withdrawn from the openings of the inner frame rails 170b and/or the openings of the outer frame rails 170a to enable sliding.

In some implementations, the seat system 102 includes a storage space 190 that is accessible through a door 192 (see, e.g., FIGS. 4, 7, 14, 17, 18, and 20). In some examples, the storage space 190 can be defined between the front seat shell 102b, the door 192, and a seatback 194 (see, e.g., FIGS. 1, 3, 5, 13, and 20). The door 192 can be opened to enable access to the storage space 190.

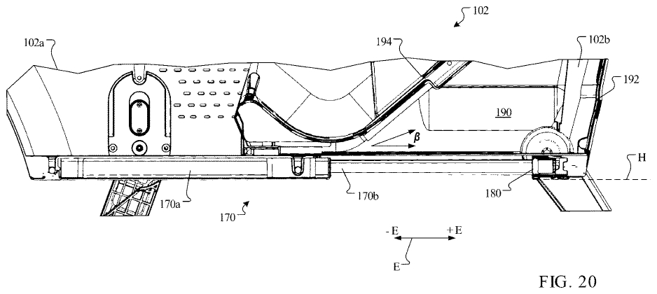

In some implementations, the seatback 194 (at least one or more components thereof) can have an incline angle that is adjustable. For example, the seatback 194 (at least one or more components thereof) can be at an angle α relative to the horizontal plane H, while the child transport system 100 is in the bucket carrier configuration, car seat configuration, or the stroller configuration (see, e.g., FIG. 2). As another example, the seatback 194 (at least one or more components thereof) can be at an angle β relative to the horizontal plane H, while the child transport system 100 is in the wagon configuration (see, e.g., FIG. 20). In some examples, the angle α is greater than the angle β. Accordingly, when the child transport system 100 is in the bucket carrier configuration, car seat configuration, or the stroller configuration, a child occupying the child transport system 100 is in a seated position, and, when the child transport system 100 is in the wagon configuration, the child is in a relatively supine position. That is, the seated position is more inclined relative to the supine position and the supine position is less inclined relative to the seated position.

In some implementations, the headrest 102c is adjustable along a linear axis that is parallel to the angle of incline of the seatback 194. For example, a headrest locking mechanism 102c is provided that locks the headrest 102c in position along the linear axis parallel to the angle of incline. In some examples, a button 196 (see, e.g., FIGS. 1 and 3) is provided and can be actuated (e.g., by a user) to release the headrest locking mechanism and adjust a position of the headrest 102c along the linear axis. In some examples, other components, such as padding that covers the seatback 194, can be attached to the headrest 102c and slides with the headrest 102c as the headrest 102c is adjusted.

In some implementations, the child transport system 100 includes suspension systems that absorb energy from various bumps and other kinetic impacts when operating in the stroller configuration or the wagon configuration. For example, and with reference to FIGS. 8 and 11, the child transport system 100 includes rear suspension systems 200 and front suspension systems 202

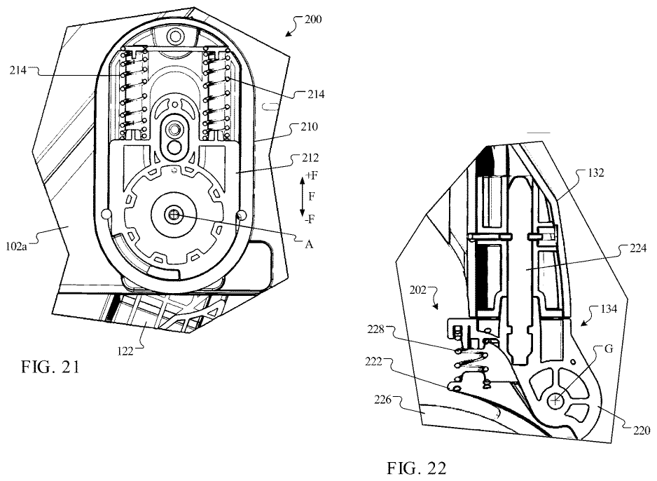

FIG. 21 depicts a cross-sectional view of the rear suspension system 200. In the example of FIG. 21, the rear suspension system 200 is integrated into the hubs 104c and includes an outer carrier 210 and an inner carrier 212. The outer carrier 210 is secured to the rear seat shell 102a for movement therewith. For example, the outer carrier 210 can be integrally formed as part of the rear seat shell 102a or can be secured using fasteners. The inner carrier 212 is disposed within the outer carrier 210 and is slidable along a linear axis F. In the depicted example, springs 214 are disposed between the inner carrier 212 and the outer carrier 210. The springs 214 each bias the inner carrier 212 in the −F direction of the linear axis F. The rear wheel assembly 104a is secured for linear travel with the inner carrier 212, while selectively rotatable about the axis A, as described herein. In response to a force acting on the rear wheel assembly 104a (e.g., rolling over a bump), the inner carrier 212 can move along the +F direction of the axis F against the bias of the springs 214.

FIG. 22 depicts a cross-sectional view of the front suspension system 202. In the example of FIG. 22, the front suspension system 202 is integrated within the wheel assembly 134. For example, the wheel assembly 134 includes an upper hub 220 and a lower hub 220. The lower hub 220 is pivotably connected to the upper hub 220 to enable the lower hub 220 to pivot about an axis G. A pin 224 is secured to and extends from the upper hub 220 to enable the wheel assembly 134 to be releasably secured to the leg assembly 132. A wheel 226 is rotatably coupled to the lower hub 220. A spring 228 is disposed between the upper hub 220 and the lower hub 222 to bias the lower hub 222 about the axis G away from the upper hub 220. In response to a force acting on the wheel 226 (e.g., rolling over a bump), the lower hub 222 can rotate about the axis G against the bias of the spring 228.

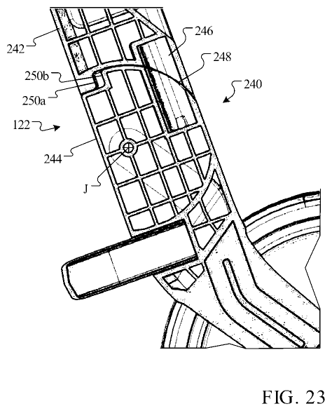

FIG. 23 depicts a cross-sectional view of a leg assembly suspension system 240 of the child transport system 100 of the present disclosure. The leg assembly suspension system 240 is provided in each of the leg assemblies 122 of the rear wheel assemblies 104a, 104b. In the example of FIG. 23, the leg assembly suspension system 240 includes a first leg component 242 that is rotatably coupled with a second leg component 244 to at least partially rotate about an axis J. A compressible member 246 (e.g., spring, elastic bushing) spans and is seated in each of the first leg component 242 and the second leg component 244. In some examples, as the first leg component 242 and the second leg component 244 are induced to rotate relative to one another about the axis J (e.g., in response to rolling over a bump), the compressible member 246 is compressed and pushes against the rotation. In the example of FIG. 23, the first leg component 242 and the second leg component 244 meet at an arcuate interface 248. In some examples, the first leg component 242 and the second leg component 244 include respective stop faces 250a, 250b that limit a degree of rotation about the axis J.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A child transport system, comprising:
a seat system comprising a first seat shell, a second seat shell, and an extendible frame, the first seat shell and the second seat shell each being attached to the extendible frame, the first seat shell being slidable along a linear axis relative to the second seat shell between a first position and a second position;
a set of front wheel assemblies rotatably attached to the seat system; and
a set of rear wheel assemblies rotatably attached to the seat system.

2. The child transport system of claim 1, wherein the child transport system is configurable between multiple configurations comprising:
a stroller configuration, in which the seat system is in the first position and each of the set of front wheel assemblies and the set of rear wheel assemblies is in an extended position; and
a wagon configuration, in which the seat system is in the second position and each of the set of front wheel assemblies and the set of rear wheel assemblies is in the extended position.

3. The child transport system of claim 1, wherein the multiple configurations further comprise a bucket carrier configuration, in which the seat system is in the second position and each of the set of front wheel assemblies and the set of rear wheel assemblies is in a stowed position.

4. The child transport system of claim 1, further comprising a car seat base, the seat system being configured for releasable attachment to the car seat base, the child transport system being configurable to a car seat configuration, in which the seat system is in the second position and each of the set of front wheel assemblies and the set of rear wheel assemblies is in a stowed position and the seat system is attached to the car seat base.

5. The child transport system of claim 1, wherein the extendible frame comprises sets of frame rails, each set of frame rails comprising a first frame rail and a second frame rail, the first seat shell being attached to each of the first frame rails, the second seat shell attached to each of the second frame rails.

6. The child transport system of claim 5, wherein the first frame rail is slidable within the second frame rail.

7. The child transport system of claim 1, further comprising a headrest that is adjustable along a linear axis that is parallel to an angle of incline of a seatback of the seat system.

8. The child transport system of claim 1, further comprising one or more of a set of suspension systems integrated into hubs of the set of rear wheel assemblies and hubs of the set of front wheel assemblies and a set of suspension systems integrated into legs of the set of rear wheel assemblies.

9. The child transport system of claim 1, further comprising a pushbar that is rotatable about an axis, rotation of the pushbar driving rotation the set of rear wheel assemblies about at least a portion of the axis.

10. The child transport system of claim 1, wherein the seat system comprises a substantially flat base that is parallel to a horizontal plane.

11. A child transport system, comprising:
a seat system comprising a first seat shell, a second seat shell, and an extendible frame, the first seat shell and the second seat shell each being attached to the extendible frame, the first seat shell being slidable within the second seat shell along a linear axis between a first position and a second position to adjust a length of the seat system along the linear axis;
a set of front wheel assemblies rotatably attached to the first seat shell; and
a set of rear wheel assemblies rotatably attached to the second seat shell;
the child transport system being configurable between multiple configurations comprising a stroller configuration, in which the seat system is locked in the first position and a wagon configuration, in which the seat system is locked in the second position.

12. The child transport system of claim 11, wherein, in the stroller configuration, each of the set of front wheel assemblies and the set of rear wheel assemblies is in an extended position and, in the wagon configuration, each of the set of front wheel assemblies and the set of rear wheel assemblies is in the extended position.

13. The child transport system of claim 11, wherein the multiple configurations further comprise a bucket carrier configuration, in which the seat system is in the second position and each of the set of front wheel assemblies and the set of rear wheel assemblies is in a stowed position.

14. The child transport system of claim 11, further comprising a car seat base, the seat system being configured for releasable attachment to the car seat base, the child transport system being configurable to a car seat configuration, in which the seat system is in the second position and each of the set of front wheel assemblies and the set of rear wheel assemblies is in a stowed position and the seat system is attached to the car seat base.

15. The child transport system of claim 11, wherein the extendible frame comprises sets of frame rails, each set of frame rails comprising a first frame rail and a second frame rail, the first seat shell being attached to each of the first frame rails, the second seat shell attached to each of the second frame rails.

16. The child transport system of claim 15, wherein the first frame rail is slidable within the second frame rail.

17. The child transport system of claim 11, further comprising a headrest that is adjustable along a linear axis that is parallel to an angle of incline of a seatback of the seat system.

18. The child transport system of claim 11, further comprising one or more of a set of suspension systems integrated into hubs of the set of rear wheel assemblies and hubs of the set of front wheel assemblies and a set of suspension systems integrated into legs of the set of rear wheel assemblies.

19. The child transport system of claim 11, further comprising a pushbar that is rotatable about an axis, rotation of the pushbar driving rotation the set of rear wheel assemblies about at least a portion of the axis.

20. The child transport system of claim 11, wherein the seat system comprises a substantially flat base that is parallel to a horizontal plane.
